(19) United States
(12) Patent Application Publication
(10) Pub. No.: US 2009/0265237 A1
(43) Pub. Date: Oct. 22, 2009

(54) Advertising Light Fixture and Method for Distribution of Same

(75) Inventors: David W. deMartino, Highland Beach, FL (US); Patricia A. deMartino, Highland Beach, FL (US); William C. Stone, Clarksville, MD (US); Robert I. Claire, Columbia, MD (US)

Correspondence Address: WHITEFORD, TAYLOR & PRESTON, LLP;ATTN: GREGORY M STONE, SEVEN SAINT PAUL STREET, BALTIMORE, MD, 21202-1626, US

(73) Assignee: Brietino Enterprises, Inc., Boca Raton, FL (US)

(21) Appl. No.: 12/426,594

(22) Filed: Apr. 20, 2009

Related U.S. Application Data
(60) Provisional application No. 61/046,107, filed on Apr. 18, 2008.

(51) Int. Cl. G06Q 30/00

(52) U.S. Cl. 705/14

(57) ABSTRACT

Disclosed is a system, method, and program for promoting the replacement of lower energy efficiency equipment with higher energy efficiency equipment, and more particularly less energy efficient lighting systems with more highly energy efficient lighting systems, is disclosed. High energy efficiency lighting fixtures are fitted with preferably removable and replaceable translucent acrylic diffuser overlays that are printed with advertising content from a third party advertiser. A program administrator arranges for such advertising content from one or more third party advertisers, and uses the advertising revenue generated from such third party advertiser to offset the costs incurred by an end user that is purchasing the high energy efficiency equipment that bears the third party advertiser's advertising content. By reducing the end user's up front expense, they are more inclined to undertake a retrofit program to replace their old, antiquated, and less energy efficient equipment with new, updated, and more energy efficient equipment.

### CROSS-REFERENCE TO RELATED APPLICATIONS

This application is based upon and gains priority from U.S. Provisional Patent Application Ser. No. 61/046,107, entitled “Advertising Light Fixture and Method for Distribution of Same”, filed with the U.S. Patent and Trademark Office on Apr. 18, 2008 by the inventors herein, the specification of which is incorporated herein by reference.

### BACKGROUND OF THE INVENTION

1. Field of the Invention

This invention relates to the distribution of highly energy efficient equipment, and more particular to systems and methods for incentivizing the replacement of less energy efficient equipment with higher energy efficient equipment through third party subsidization of the cost of such equipment.

2. Description of the Background

The desire to find strategies to conserve energy has become a global priority. In the realm of ever increasing energy consumption and the associated expenses, concern continues to grow that resources are being depleted at a pace that is unsustainable. As a result, efforts have been undertaken to encourage energy consumers to reduce their energy usage, such as by remediating antiquated equipment in schools, factories, businesses, government offices, etc. with newer, more highly energy efficient equipment, such as lighting systems, heating, ventilating, and air condition (“HVAC”) equipment, power distribution systems, and any other systems that consume energy in their operation. For example, currently the American Recovery and Reinvestment Plan of 2009 seeks to encourage the retrofitting of old buildings with new and more highly efficient lighting fixtures in an effort to reduce energy consumption.

However, despite the wisdom in seeking to reduce energy consumption, the costs associated with such highly energy efficient systems and improvements have served as a primary obstacle to their widespread adoption. While tax incentives and rebate programs from utility companies have provided good, initial steps to encourage the retrofit of aged buildings with new, highly energy efficient equipment, barriers nonetheless remain. For instance, the initial costs of such high efficiency equipment can be sufficiently high such that rebates or other incentives offered to the end user from the new product do not provide economic benefit over the old product, even after accounting for the reduced energy costs incurred by the end user. Moreover, given the current global economic malaise companies, governmental entities, and citizens are facing, it is even less likely that many will entertain incurring the expense of an equipment retrofit without significant increase in the economic benefits to be had by all persons involved in the retrofitting process.

Therefore, it would be advantageous to provide a method, system, and program promoting the replacement of less energy efficient equipment, such as antiquated lighting systems, with higher efficiency equipment using incentives applicable to all persons or entities involved in a potential retrofit project. It would be further advantageous to provide a method, system, and program promoting the replacement of lower efficiency equipment with higher efficiency equipment whereby an ongoing, easily calculable revenue stream remains available to the varied entities involved with providing such method, system, and program, while reducing the expenses incurred by the end user of such higher efficiency equipment.

It would be further advantageous to provide a method, system, and program promoting the replacement of lower efficiency equipment with higher efficiency equipment in which a third party at least partially funded the end user's purchase of such higher efficiency equipment from a program administrator in exchange for promotion of such third party, such as by including advertising content of such third party on the higher efficiency equipment that is to be installed by the program administrator at the end user's location.

### SUMMARY OF THE INVENTION

In accordance with a particularly preferred embodiment of the invention, a system, method, and program for promoting the replacement of lower energy efficiency equipment with higher energy efficiency equipment, and more particularly less energy efficient lighting systems with more highly energy efficient lighting systems, is disclosed. High energy efficiency lighting fixtures, such as the Series RDI Recessed Direct/Indirect lighting fixture that is commercially available from Mobern Lighting Company of Laurel, Md., are fitted with preferably removable and replaceable translucent acrylic diffuser overlays that are printed with advertising content from a third party advertiser. The fixtures are configured to provide both direct and indirect lighting while simultaneously backlighting the advertising content on the overlay. A program administrator, optionally in conjunction with one or more program partners (e.g., fixture or other equipment manufacturers, distributors, etc.) arranges for such advertising content from one or more third party advertisers, and uses the advertising revenue generated from such third party advertiser to offset the costs incurred by an end user that is purchasing the high energy efficiency equipment that bears the third party advertiser's advertising content. By reducing the end user's up front expense, they are more inclined to undertake a retrofit program to replace their old, antiquated, and less energy efficient equipment with new, updated, and more energy efficient equipment. Moreover, through the ongoing revenue stream that is generated through the advertising fees received from the third party advertiser, both the end user and the program administrator are further incentivized to undertake such retrofit program. Likewise, deferring the administrative task of administering the program to a program administrator eases the effort required of the end user to participate, while providing a profitable business opportunity for such program administrator.

### DESCRIPTION OF THE DRAWINGS

The above and other features, aspects, and advantages of the present invention are considered in more detail, in relation to the following description of embodiments thereof shown in the accompanying drawings, in which:

FIG. 1 is a schematic view of an exemplary program for promoting the installation of new energy efficient equipment according to one aspect of a particularly preferred embodiment of the invention.

FIG. 2 is a flowchart depicting an exemplary method for promoting the installation of new energy efficient equipment according to one aspect of a particularly preferred embodiment of the invention.

FIG. 3 is an exemplary advertisement placement auction screen for use in the method of FIG. 2.

FIG. 4 is a perspective view of a highly energy efficient equipment item for use with the method of FIG. 2.

FIG. 5 is a cross sectional view of the highly energy efficient equipment of FIG. 4.

FIG. 6 is a bottom view of the highly energy efficient equipment of FIG. 4.

### DETAILED DESCRIPTION OF THE PREFERRED EMBODIMENTS

The invention summarized above may be better understood by referring to the following description, which should be read in conjunction with the accompanying drawings in which like reference symbols are used for like parts. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

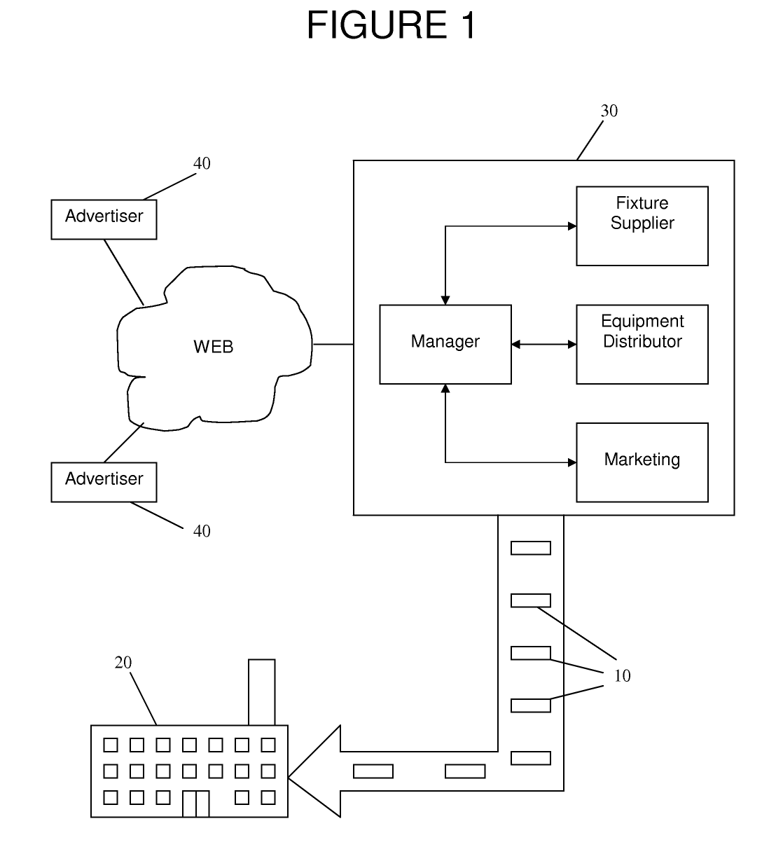

Disclosed herein is a method, system, and program for promoting the replacement of less energy efficient equipment with more highly energy efficient equipment, and more particularly less energy efficient lighting systems with more highly energy efficient lighting systems. More particularly, as shown in the schematic view of FIG. 1, highly energy efficient equipment 10, such as high energy efficiency lighting systems, are provided to end users 20 through and/or at the direction of a program administrator 30 at a reduced cost to the end user through offset payments received from a third party advertiser 40. One or more third party advertisers 40 provide advertising content to the program administrator 30 (optionally communicating with an automated program administrator computer server through a wide area network, such as the Internet, for purposes of purchasing advertisement placement on highly energy efficient equipment 10 and for providing advertising content to program administrator 30 for integration with such highly energy efficient equipment 10), who in turn integrates the advertising content with the highly energy efficient equipment 10 such that when such equipment is installed at the end user's location, the advertising content is visible.

As used herein, a program administrator 30 may be, for example, a manufacturer or supplier of high energy efficiency equipment, an engineering firm, a project manager, a construction manager, a fixture company, a lighting or heating service company, an energy services company, a fixture marketing company, or the like. Moreover, a program administrator may comprise any combination of such entities, and may include other entities working in conjunction with the foregoing. An end user 20 may, in turn, comprise any energy consuming facility such as office buildings, government buildings, warehousing and storage facilities, retail businesses, non-profit organization offices, and any other physical establishment that might enjoy reduced energy costs through retrofitting of highly energy efficient equipment. Still further, third party advertisers 40 may comprise any entity willing to advertise on a piece of equipment, such as a lighting fixture, in a third party facility.

In order to reduce the costs that an end user would incur in updating old, less energy efficient equipment with new, more highly energy efficient equipment, a program is provided whereby the purchase price for which the end user 20 pays for such highly energy efficient equipment is offset by third party advertising revenue received from one or more third party advertisers 40 whose advertising content is placed on such highly energy efficient equipment 10. The discount that is applied to the end user's purchase price may be, by way of non-limiting example, a rebate to the end user in some amount associated with the advertising income generated from the third party advertisers 40 whose messages are provided on the new, highly energy efficient equipment. For instance, the rebate may be in the form of a one time reduction in the end user's 20 purchase price of the new equipment. Alternatively, the rebate may be in the form of a one time payment back to the end user 20, or may be a recurring payment, such as some portion or the entirety of ongoing advertising revenue received from the third party advertiser 40. Further, the rebate may be an amount equal to the full amount of the revenue received from the third party advertiser 40, or more preferably a portion of the revenue received from the third party advertiser 40, with an additional portion of such revenue flowing to the program administrator 30 and/or other program participants in cooperation with the program administrator.

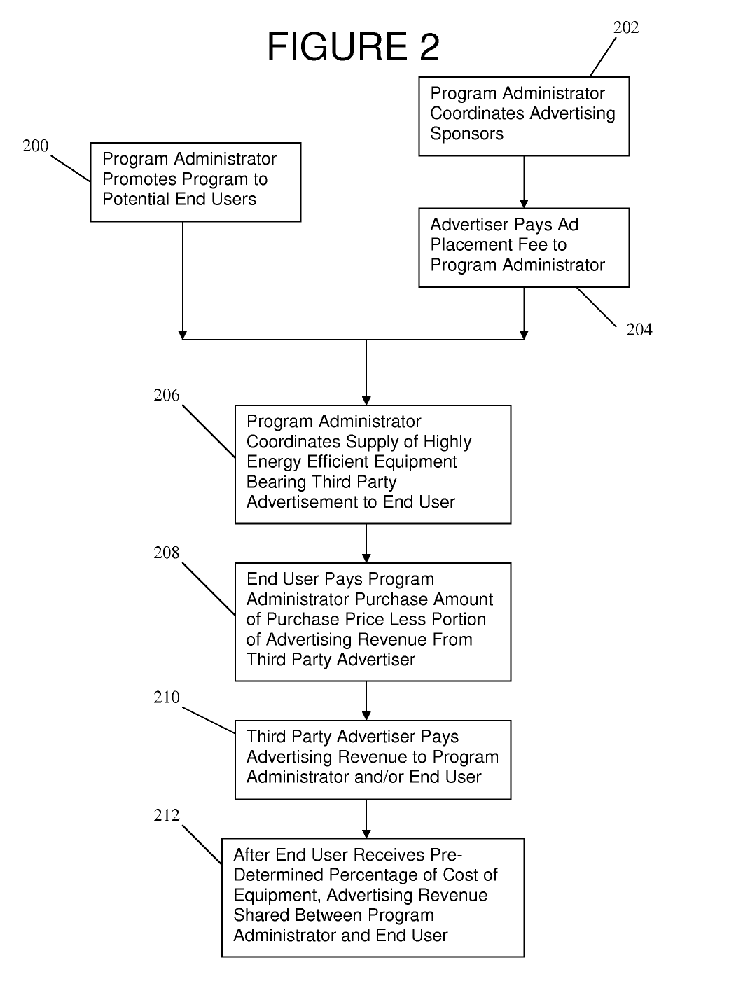

As shown in the flow chart of FIG. 2 depicting one particularly preferred embodiment of the program for promoting the replacement of old, less energy efficient equipment with new, more highly energy efficient equipment, the program administrator 30, for example comprising a fixture manufacturer, a distributor, etc., may at step 200 promote the program described herein by working directly with the end user 20 or by working in partnership with other marketers and/or developers as “project partners,” who as described above may herein be collectively referred to as the project administrator 30. The program administrator 30 will also preferably coordinate with each end user 20 to, at step 202, identify and arrange for third party advertising sponsor(s) 40, preferably on a competitive bid, “number of fixtures over time” basis, for each project. In turn, the project administrator 30 will preferably receive at step 204 a placement fee and/or commission payable by the advertiser or other sponsor 40 (i.e., a “buyer's premium”) for placing sponsorship advertising. In most cases, the program administrator 30 will, at step 206, contract directly with the end user 20 for the purchase of the qualifying lighting equipment, who in turn at step 208 will pay the program administrator 30 a purchase amount equal to the purchase price of the equipment 10 less a rebate equaling some portion (e.g., a predetermined percentage) of the advertising revenue received from the third party advertiser(s) 40. In addition to receiving a rebate/discount off of the purchase price as a result of the third party advertisement fees, the end user 20 will preferably also receive the associated tax credits, deductions, and/or energy efficiency rebates earned in connection with its purchase of highly energy efficient equipment to further defray, at least in part, the cost of the qualifying equipment. Alternatively, it is envisaged that the program administrator 30 may receive such tax credit, deduction, and/or energy efficiency rebates and in turn further reduce the purchase price charged to the end user 20. At step 210, the advertising or sponsorship revenue may be paid to the end user 20 up front as a lump sum payment, over the term of the advertising or sponsorship contract, or in any other manner in order to allow the end user 20 to recoup the cost of purchasing the qualifying equipment 10, particularly in the case where the end user 20 is a commercial entity. Alternatively, the advertising or sponsorship revenue may be paid to the program administrator and/or its project partner, particularly in the case where the end user 20 is a not-for-profit or institutional end user. Once the end user 20 has recovered 100% of the cost of the project, at step 212 advertising and/or sponsorship revenue is preferably shared equally between the end user 20 and the distribution manager 30.

The advertising or sponsorship revenue that is generated for the end user 20 by the distribution manager 30 may be determined on a project-by-project basis, preferably using one of the following methods:

(i) The end user 20 provides the program administrator 30 with a closed list of potential advertisers and/or sponsors 40, optionally together with the rate that each such advertiser and/or sponsor shall be charged. The program administrator 30 will in turn preferably receive a commission payment, for example in the form of a percentage of the advertising or sponsorship revenue, or even of the purchase price of the particular fixtures being provided to the end user 20, from either the advertiser/sponsor 40 or the end user 20, preferably as specified by the end user 20.

(ii) The program administrator 30 may develop a list of potential advertisers/sponsors 40 which it believes to be suitable for display within the end user facility. The end user 20 may then approve or reject the names on the list, and the program administrator 30 may negotiate the advertising/sponsorship revenue to be paid by each potential advertiser/sponsor 40 on behalf of the end user 20. The program administrator 30 may again receive a commission payment on all advertising and/or sponsorship placed, which amount may be paid by the respective advertiser and/or sponsor 40.

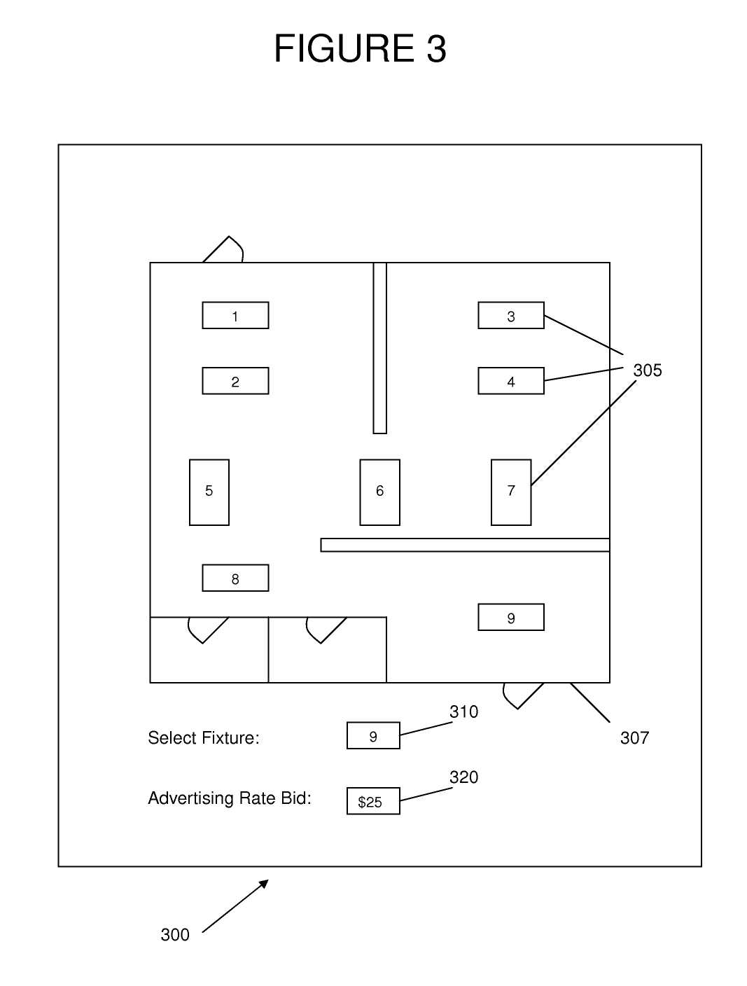

(iii) The program administrator, through an auction process, such as by way of non-limiting example an online auction process via the World Wide Web, may hold out each project for bid to a pool of potential advertisers and/or sponsors (worldwide) using virtual displays over the Internet. With particularly reference to FIG. 1 and schematic view of an exemplary advertisement placement auction screen (shown generally at 300) as shown in FIG. 3, each proposed light fixture may be designated on the virtual display, and may be identified by a location (for instance, through labeling with a number, letter, or other designation) within the end user facility. During the auction process, advertisers and/or sponsors 40 may bid on any fixture location 305 within a schematic map 307 of the selected end user facility by entering a fixture location selection in field 310 and an advertising rate bid in field 320. Thereafter, the highest bidder, subject to approval by the end user 20, may then secure the designated fixture location. The highest bidder may also be required to pay a “buyer's premium” commission payment to the program administrator 30.

In addition to revenue generated through the placement of advertisement or sponsorships as described above, additional revenue may be generated and flow to the program administrator 30 in the form of a fixed fee payment from a manufacturer of fixtures to be used in such distribution program, such as a flat fee per fixture.

Additionally, it is envisaged that through the use of high energy efficiency equipment being used as the fixtures incorporating advertising and promotional messages as described above, carbon credits (such as are available from and marketable on the Chicago Climate Exchange) may be earned from the qualifying retrofit project, and may be retained either by the end user to further subsidize the cost of the qualifying equipment, or be assigned by the host to the distribution manager or its project partner, as additional compensation for developing the project.

While the cost to retrofit institutional and industrial buildings (both public and private) may, in many cases and at first consideration, be cost prohibitive, the program described herein allows the cost of the new fixtures to be subsidized, in whole or in part, by a corporate advertiser, a “Go Green” sponsor, a donor, or any other entity who will pay for the right to have its, his, or her name and/or logo or other advertisement, promotional or other message appear on the fixture that is specified by (and to be installed in) the end user facility. In addition, the purchase of the fixture will be further subsidized through energy efficiency rebates paid by the end user's local utility company and/or available tax credits, carbon credits, and any other available credits or rebates. Such program will allow end users to better manage their short and long-term energy costs as well as their carbon footprint.

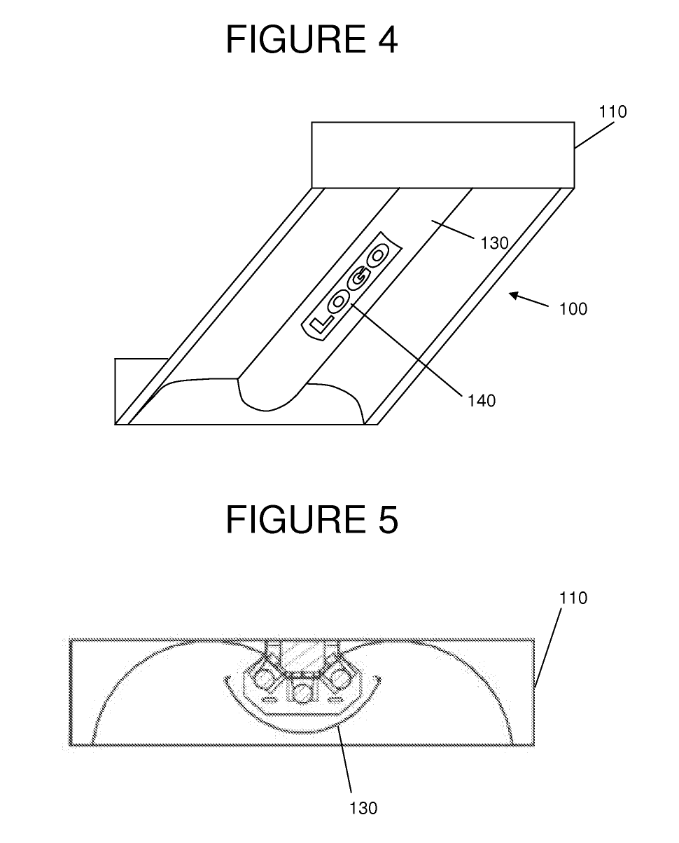

With regard to another aspect of a particularly preferred embodiment of the invention, an example of highly energy efficient equipment that is particularly well suited to the above-described program is a lighting fixture configured to receive a third party advertisement, such as the Series RDI Recessed Direct/Indirect lighting fixture that is commercially available from Mobern Lighting Company of Laurel, Md. As shown in the perspective view of FIG. 4 and the cross sectional view of FIG. 5, a lighting fixture (shown generally at 100) is provided having an outer, generally tray-like housing 110 with an open bottom and mounting light bulbs 120 in the traditional manner. The housing is preferably configured as a recessed troffer dish having a center basket 130 that provides direct and indirect light. The center basket preferably comprises a curved, single basket shaped perforated metal shield, under which is positioned a translucent, opal white acrylic diffuser overlay. The perforated basket provides direct illumination with a translucent opal white acrylic overlay diffuser for visual comfort. The perforated basket preferably flexes over mounting studs on the housing for easy installation and servicing of the bulbs, such that the bulbs are generally hidden from view when the fixture is installed. Particularly, the screen may be removed in order to service the bulbs. While the perforations allow some light to shine through the screen, much of the illumination comes from reflection off of the back of the screen/diffuser and then off of the interior of the housing 110.

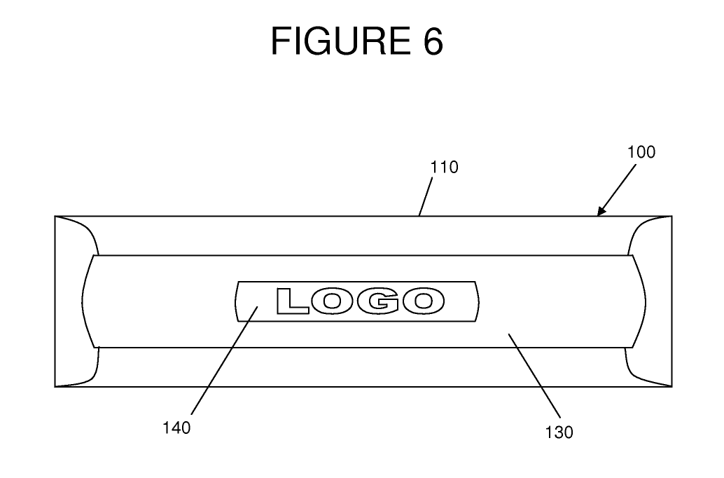

As shown in FIG. 4 and the bottom view of FIG. 6, a message 140, such as an advertising message, is applied to the perforated screen on its outer face so as to be visible from below the fixture. For instance, an advertising or promotional message may be plotted into vinyl and applied to the face of the metal screen or of the acrylic overlay so as to be visible from below the fixture. The vinyl label preferably comprises a silk-screened image produced from ultraviolet-stabilized ink, such that the image will not degrade over time despite its close proximity to the light source. The fixture thus provides the standard lighting function through the reflected light while at the same time providing a back-lit, illuminated advertisement. Particularly, when the fixture is illuminated, the advertising or promotional message is illuminated through the acrylic face of the light fixture.

The invention has been described with references to a preferred embodiment. While specific values, relationships, materials, and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments shown and described will obviously occur to those skilled in the art upon becoming familiar with said underlying concept. It is intended to include all such modifications, alternatives and other embodiments in this invention. It should be understood, therefore, that the invention may be practiced otherwise than as specifically set forth herein. Consequently, the present embodiments are to be considered in all respects as illustrative and not restrictive.

1. A method for promoting the installation of new energy efficient equipment comprising:
receiving an order for advertisement placement from a third party advertiser in exchange for agreement from said third party advertiser to pay an advertisement revenue amount; and
providing to a third party end user, for a predetermined purchase amount, an energy efficient equipment item bearing said advertisement placement;
wherein said predetermined purchase amount due from said third party end user is offset by an amount equal to a predetermined portion of said advertisement revenue amount.

2. The method of claim 1, wherein said energy efficient equipment item further comprises a higher efficiency lighting fixture having a higher energy efficiency rating than a preexisting lighting fixture installed at a facility of said third party end user, and wherein said preexisting lighting fixture is selected for replacement with said higher efficiency lighting fixture.

3. The method of claim 2, wherein said higher efficiency lighting fixture further comprises a removable, translucent insert, wherein said insert is printed with said advertisement placement from said third party advertiser.

4. The method of claim 3, wherein said removable translucent insert simultaneously provides direct lighting through said overlay, indirect lighting reflected off of a back side of the overlay and an interior of said fixture housing, and backlighting of said advertisement placement.

5. The method of claim 4, wherein said removable translucent insert further comprises a curved, perforated metal shield and a translucent, acrylic diffuser overlay.

6. The method of claim 3, wherein said fixture housing comprises a recessed troffer dish.

7. The method of claim 3, wherein said advertisement placement is positioned on said insert on an outer face thereof so as to be visible from below when said higher efficiency lighting fixture is installed.

8. The method of claim 3, wherein said advertisement placement comprises a silk screened image produced from ultraviolet stabilized ink plotted onto a vinyl sheet which is applied to said insert.

9. The method of claim 1, further comprising the step of:
receiving an advertisement placement fee from said third party advertiser.

10. The method of claim 1, further comprising the step of receiving third party credits associated with the supply of said energy efficient equipment.

11. The method of claim 10, further comprising the step of further reducing the predetermined purchase amount due from said third party end user by an amount equal to some predetermined portion of said third party credits.

12. The method of claim 1, wherein at least some portion of said advertisement revenue amount is paid to said third party end user by said third party advertiser.

13. The method of claim 12, wherein said payment to said third party end user by said third party advertiser further comprises an up front, lump sum payment made prior to said predetermined purchase price being due from said third party end user.

14. The method of claim 12, wherein said payment to said third party end user by said third party advertiser further comprises multiple payments made over time during the duration of said advertisement placement.

15. The method of claim 1, further comprising receiving at least a portion of said advertisement revenue amount from said third party advertiser.

16. The method of claim 15, further comprising the step of reducing said predetermined purchase amount due from said third party end user by an amount equal to a predetermined portion of said advertisement revenue amount received from said third party advertiser.

17. The method of claim 1, wherein at least some portion of said advertisement revenue amount is paid to said third party end user by said third party advertiser, further comprising the step of:
upon said third party end user receiving cumulative advertising revenue in an amount equal to a predetermined portion of said purchase amount due from said third party end user, thereafter receiving a predetermined portion of additional advertising revenue from said third party advertiser.

18. A method for promoting the installation of new energy efficient equipment comprising:
placing an order for advertisement placement with an equipment supply program administrator in exchange for agreement to pay an advertisement revenue amount, wherein said advertisement placement further comprises advertising content positioned on an energy efficient equipment item supplied by said equipment supply program administrator to a third party end user for a predetermined purchase amount due from said third party end user to said program administrator, and wherein said predetermined purchase amount due to said program administrator from said third party end user is offset by an amount equal to a predetermined portion of said advertisement revenue amount.

19. The method of claim 18, wherein said energy efficient equipment item further comprises a higher efficiency lighting fixture having a higher energy efficiency rating than a preexisting lighting fixture installed at a facility of said third party end user, and wherein said preexisting lighting fixture is selected by said program administrator for replacement with said higher efficiency lighting fixture.

20. The method of claim 19, wherein said higher efficiency lighting fixture further comprises a removable, translucent insert, wherein said insert is printed with said advertisement placement from said third party advertiser.

21. The method of claim 18, further comprising the step of:
paying an advertisement placement fee to said program administrator.

22. The method of claim 18, further comprising the step of paying at least some portion of said advertisement revenue amount to said third party end user.

23. The method of claim 22, wherein said payment to said third party end user further comprises an up front, lump sum payment made prior to said predetermined purchase price being due from said third party end user to said program administrator.

24. The method of claim 22, wherein said payment to said third party end user further comprises multiple payments made over time during the duration of said advertisement placement.

25. The method of claim 18, further comprising the step of paying at least a portion of said advertisement revenue amount to said program administrator.

26. The method of claim 25, wherein said predetermined purchase amount due to said program administrator from said third party end user is reduced by an amount equal to a predetermined portion of said advertisement revenue amount paid to said program administrator.

27. The method of claim 18, further comprising the steps of:
paying at least some portion of said advertisement revenue amount to said third party end user; and
upon said third party end user receiving cumulative advertising revenue in an amount equal to a predetermined portion of said purchase amount due to said program administrator from said third party end user, thereafter paying a predetermined portion of additional advertising revenue to said program administrator.

28. A method for promoting the installation of new energy efficient equipment comprising:
in exchange for agreement to pay a predetermined purchase amount, receiving from an equipment supply program administrator an energy efficient equipment item bearing an advertisement placement;
wherein said advertisement placement comprises advertising content received by said program administrator from a third party advertiser in exchange for an agreement from said third party advertiser to pay an advertisement revenue amount; and
wherein said predetermined purchase amount payable to said program administrator is offset by an amount equal to a predetermined portion of said advertisement revenue amount.

29. The method of claim 28, wherein said energy efficient equipment item further comprises a higher efficiency lighting fixture having a higher energy efficiency rating than a preexisting lighting, and wherein said preexisting lighting fixture is selected by said program administrator for replacement with said higher efficiency lighting fixture.

30. The method of claim 29, wherein said higher efficiency lighting fixture further comprises a removable, translucent insert, wherein said insert is printed with said advertisement placement from said third party advertiser.

31. The method of claim 28, further comprising the step of:
receiving at least some portion of said advertisement revenue amount from said third party advertiser.

32. The method of claim 31, wherein said payment received from said third party advertiser further comprises an up front, lump sum payment made prior to said predetermined purchase price being due to said program administrator.

33. The method of claim 31, wherein said payment received from said third party advertiser further comprises multiple payments made over time during the duration of said advertisement placement.

34. The method of claim 28, wherein at least a portion of said advertisement revenue amount is paid by said third party advertiser to said program administrator, and wherein said predetermined purchase amount due to said program administrator is reduced by an amount equal to a predetermined portion of said advertisement revenue amount paid to said program administrator.

35. The method of claim 28, further comprising the steps of:
receiving at least some portion of said advertisement revenue amount from said third party advertiser; and
upon receiving cumulative advertising revenue in an amount equal to a predetermined portion of said purchase amount due to said program administrator, thereafter receiving a predetermined shared portion of additional advertising revenue, with a remainder of said additional advertising revenue being paid by said third party advertiser to said program administrator.
